(19) United States
(12) Patent Application Publication
(10) Pub. No.: US 2009/0013057 A1
(43) Pub. Date: Jan. 8, 2009

(54) Data file transmission method and wireless communication device

(75) Inventor: Hironori Suzuki, Tokyo (JP)

Correspondence Address: GIBSON & DERNIER L.L.P., 900 ROUTE 9 NORTH, SUITE 504, WOODBRIDGE, NJ, 07095, US

(73) Assignee: Sony Computer Entertainment Inc., Tokyo (JP)

(21) Appl. No.: 11/484,422

(22) Filed: Jul. 11, 2006

(30) Foreign Application Priority Data
Jul. 13, 2005 (JP) 2005-204099

(51) Int. Cl. G06F 15/16

(52) U.S. Cl. 709/217

(57) ABSTRACT

A storage in a wireless communication terminal stores at least one data file. A data file selector selects a data file from among the data files stored in the storage, in accordance with an instruction from a user acknowledged in an acknowledging unit. A search unit searches for a wireless communication terminal originating a download request signal requesting a download of a data file. A transmission destination selector selects a transmission destination wireless communication terminal from among the wireless communication terminals identified through the search, in accordance with an instruction from a user acknowledged in the acknowledging unit. A transmitter transmits the selected data file to the transmission destination wireless communication terminal.

### BACKGROUND OF THE INVENTION

1. Field of the Invention

The present invention relates to a technology for communicating between a plurality of communication terminals and, more particularly, to a technology for transmitting data files such as image files.

2. Description of the Related Art

With the realization of miniaturization and lightweight of information terminals, it has become common for people to carry an information terminal. Wireless communication environment in which a plurality of users can exchange data files such as game programs and image files using infrastructure such as base stations and access points has become a reality in recent years. Vigorous study has also been carried out on the construction of wireless ad hoc network for on-demand communication. In an ad hoc network, base stations and access points are not necessary. It is therefore easy to build a wireless network even in places where no such infrastructure exists. In an ad hoc network, a plurality of users can exchange data files as they join each other, bringing their own portable wireless communication devices and communicating wirelessly.

An infrastructure network and an ad hoc network are built using technologies such as IEEE802.11 or Bluetooth. A wireless communication environment conventionally assumed is such that several terminals are brought together so that communication is achieved between the terminals. In an infrastructure network or an ad hoc network, however, a situation could occur in which as many as 10-100 terminals are brought together in the same environment.

In a wireless network using IEEE802.11, a Basic Service Set (BSS) is prescribed as a basic unit of group comprising terminals communicating with each other. BSS refers to a set which is a group of mutually communicating terminals. Terminals belonging to the same BSS can communicate with each other. A BSS is identified by an 48-bit identifier known as Basic Service Set ID (BSSID). A unique value in the environment is assigned to a BSSID. There is also available a Service Set ID (SSID) comprised of a character string of 0-32 bytes to discriminate between BSSs. SSID is arbitrarily configured. The same SSID may be assigned to a plurality of BSSs. A BSS is formed by a terminal or an access point transmitting a reference packet called beacon. The range reached by the beacon defines a spatial range of the BSS. A plurality of BSSs may be located in the same physical space.

In order for a terminal to transmit a data file to another terminal, the terminals should belong to the same BSS. One conceivable method of transmitting a data file in the same BSS could be such that a terminal maintaining a data file periodically transmits an information packet indicating that it has a data file. When the terminal receiving the information packet replies with a request for a download of the data file, the terminal maintaining the data file may transmit the data file in response to the request. If the data file transmitted is one which is generally available such as a game program, no problem is presented in broadcasting the fact that the data file is maintained. In the case of highly personal data such as data of photos taken of a person, however, it may be unfavorable to broadcast the fact that the data is maintained.

### SUMMARY OF THE INVENTION

Accordingly, a general purpose of the present invention is to provide a technology capable of transmitting a data file efficiently.

A data file transmission method according to at least one embodiment of the present invention comprises: selecting a data file to be transmitted; searching for a wireless communication terminal requesting a download of a data file; specifying a transmission destination wireless communication terminal based upon a result of the search; and transmitting the selected data file to the specified wireless communication terminal.

A wireless communication device according to at least one embodiment of the present invention comprises: a storage which stores at least one data file; an acknowledging unit which acknowledges an instruction from a user; a first selector which selects a data file from among the data files stored in the storage, in accordance with the instruction from the user acknowledged by the acknowledging unit; a search unit which searches for a wireless communication terminal originating a request to download a data file; a second selector which selects a transmission destination wireless communication terminal from among the wireless communication terminals identified through the search, in accordance with an instruction from the user acknowledged by the acknowledging unit; and a transmitter which transmits the selected data file to the transmission destination wireless communication terminal.

Optional combinations of the aforementioned constituting elements, and implementations of the invention in the form of methods, apparatuses, systems, recording mediums and computer programs may also be practiced as additional modes of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 illustrates an IBSS in an ad hoc network using IEEE802.11;

FIG. 2 illustrates the operation of a wireless communication terminal requesting a download of a data file;

FIG. 3 illustrates the operation of a wireless communication terminal transmitting a data file;

FIG. 4 is a functional block diagram showing the structure of a receiving end and a transmitting end of data file transmission;

FIGS. 5A and 5B each illustrates a list of terminals generated by a list generation unit;

FIG. 6 illustrates a state in which a plurality of IBSSs are formed in a single environment; and

FIG. 7 illustrates a variation of the operation of a wireless communication terminal transmitting a data file.

### DETAILED DESCRIPTION OF THE INVENTION

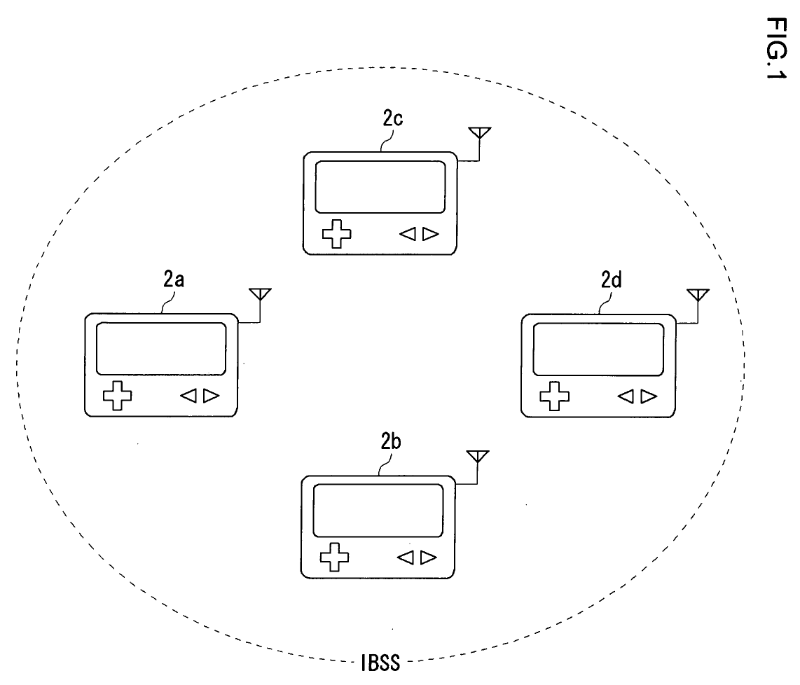

FIG. 1 is a schematic illustration of an Independent Basic Service Set (IBSS) in an ad hoc network using IEEE802.11. IBSS corresponds to a wireless network. Stations in the IBSS can directly communicate with each other. In FIG. 1, four wireless communication devices 2a, 2b, 2c and 2d (hereinafter, referred to as wireless communication terminals) are illustrated as examples. The number of wireless communication terminals 2 constituting the IBSS is not limited to four. Any number of terminals other than four may constitute the set. Each of the wireless communication terminals 2 is provided with a wireless communication function. By bringing a plurality of wireless communication terminals 2 together, a wireless network is built. A wireless ad hoc network is built by using a wireless LAN standard such as IEEE802.11. In an IBSS, communication between a plurality of wireless communication terminals 2 is achieved by building an ad hoc network without requiring infrastructure such as base stations and access points. The communication range of IBSS is called a basic service area. The basic service area is determined by the propagation characteristic of a wireless medium.

The embodiment provides a technology for transmitting and receiving a data file between two wireless communication terminals 2 in a wireless network in an IBSS mode. Highly personal image data such as data of images captured using a digital still camera is assumed as the data file transmitted in the wireless communication system according to the embodiment. In a majority of cases, such data file is personally possessed and is not something that are readily exchanged between strangers.

For this reason, it is unfavorable to broadcast the fact that a data file is maintained to all members participating in a wireless network before the data file is transmitted because that would leak personal information. In the case of a wireless network in which connection between terminals cannot be visually confirmed, seeking of members desiring to download a data file by using a broadcast signal will end up broadcasting the fact that the data file is maintained to members who are strangers. If a less personal data file is to be shared among members, seeking of members desiring to download the data file by using a broadcast signal would not present a problem. In contrast, if a highly personal data file is to be shared among specified members such as friends, an approach whereby members desiring download are sought is not appropriate.

In this background, we propose an approach whereby a member maintaining a highly personal data file can transmit the data file in response to a request from other members desiring download. In the proposed approach, receivers of a data file are not sought at a transmitter's own initiative. Instead, receivers request a transmitter to transmit a data file. With this, an owner of a data file (transmitter) need not broadcast the fact that the data file is maintained to other member of a wireless network. This prevents leakage of personal information. In the following description, a method of transmitting and receiving a data file between a wireless communication terminal 2b and a wireless communication terminal 2a belonging to the same wireless network will be explained. The wireless communication terminal 2a is a terminal desiring to download a data file, and the wireless communication terminal 2b is a terminal which maintains a data file.

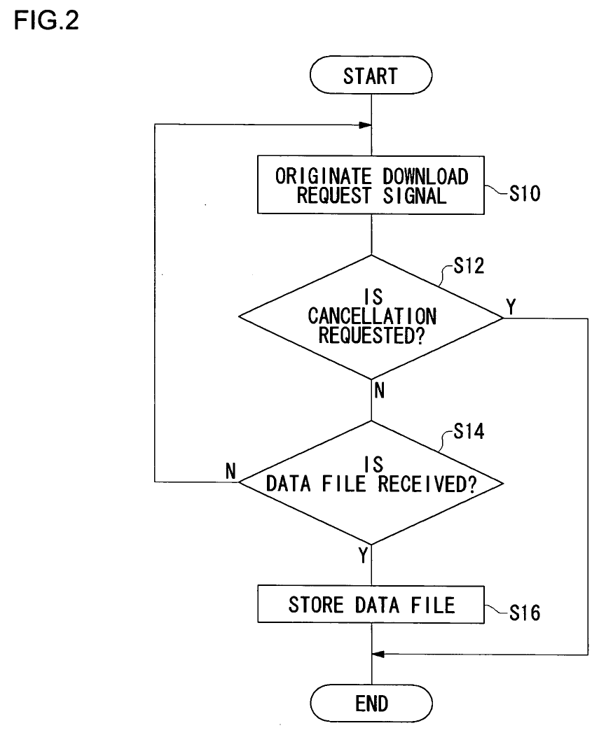

FIG. 2 illustrates the operation of a wireless communication terminal requesting a download of a data file. The wireless communication terminal 2a originates a download request signal requesting a download of a data file (S10). The download request signal does not specify a data file desired to be downloaded. It merely requests another wireless communication terminal 2 to transmit a data file. The download request signal is periodically transmitted to the wireless communication terminals 2 belonging to the same wireless network. The download request signal includes a nickname of the wireless communication terminal 2a. The nickname is preset by a user in each wireless communication terminal. When the user of the wireless communication terminal 2a requests cancellation of download (Y in S12), origination of a download request signal is cancelled, whereupon the download is cancelled.

Absent the user's instruction for cancellation of download (N in S12), the wireless communication terminal 2a continues to originate a download request signal until a data file is received (N in S14). If the wireless communication terminal 2b receiving the download request signal transmits the data file, the wireless communication terminal 2a stops originating a download request signal and receives the data file (Y in S14). The terminal 2a stores the data file in a storage means (S16). This completes a download. For example, the storage means may be an external storage device detachable from the wireless communication terminal 2a. It is assumed here that the wireless communication terminal 2a cancels the download in response to an instruction for cancellation from the user. Alternatively, the download may automatically time out if a data file cannot be received within a prescribed period of time.

In the approach for transmission and reception according to the embodiment, the wireless communication terminal 2a on the receiving end does not own a right to select a data file to be received. The data file is transmitted at the initiative of the transmitting wireless communication terminal 2. For this reason, there is a possibility that a data file is transmitted from an unexpected source. In such a case, a received image may be displayed on a monitor in S16 to prompt the user to ask whether to store the image. If the user selects not to store, the wireless communication terminal 2a discards the data file without storing it and originates a download request signal again as illustrated in S10.

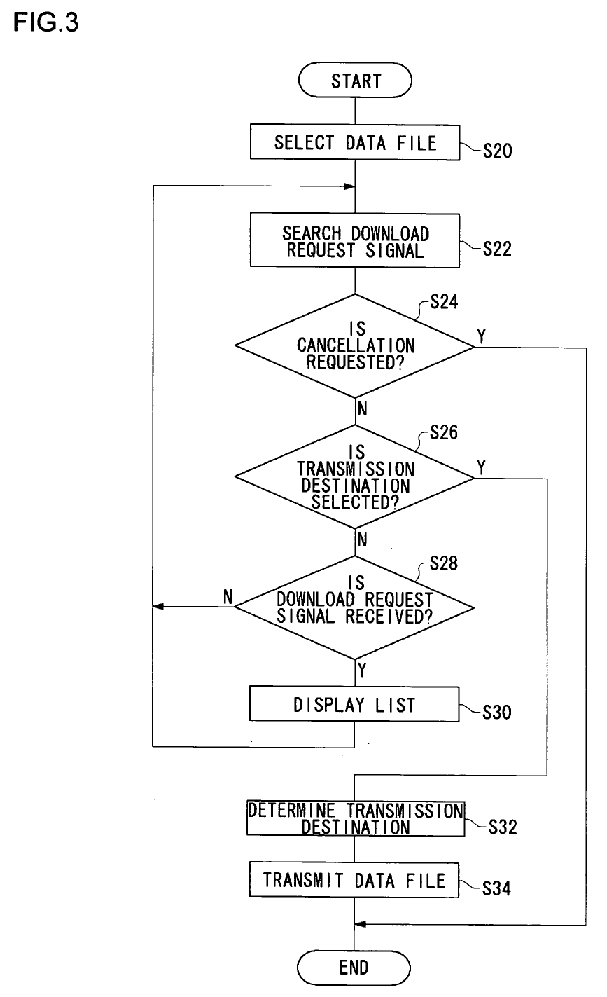

FIG. 3 illustrates the operation of a wireless communication terminal transmitting a data file. The wireless communication terminal 2b selects a data file to be transmitted in response to a user's instruction (S20). One or a plurality of data files may be selected. When a data file is selected, the wireless communication terminal 2b searches in the wireless network to which it belongs for a wireless communication terminal originating a download request signal (S22). If the user of the wireless communication terminal 2b requests cancellation of a search (Y in S24), the search for a download request signal is canceled. This completes the flow.

If the user has not requested cancellation (N in S24) and if the user has not selected a transmission destination wireless communication terminal 2 (N in S26), the wireless communication terminal 2b determines whether a download request signal is received (S28). Selection of a destination of transmission in S26 can be performed only when a list described later is displayed. The user cannot designate a destination of transmission unless a list is displayed.

If a download request signal is not received (N in S28), the search is continued. In contrast, if a download request signal is received (Yin S28), the wireless communication terminal 2b retrieves a nickname included in the download request signal and lists the nicknames. The wireless communication terminal 2b is provided with a monitor and a list of retrieved nicknames is displayed on the monitor (S30). The wireless communication terminal 2b displays the list when a single download request signal is received. After displaying the list, the wireless communication terminal continues to search for a download request signal. Each time the wireless communication terminal 2b receives a download request signal from another wireless communication terminal 2 in the search, the identified wireless communication terminal 2 is appended to the list. If a plurality of wireless communication terminals 2 are originating a download request signal in a wireless network, a list of the nicknames of a plurality of wireless communication terminals 2 is displayed on the monitor 16b of the wireless communication terminal 2b.

Once the list is displayed and the user selects the wireless communication terminal 2a from the listed wireless communication terminals 2 (Y in S26), the wireless communication terminal 2b determines that the wireless communication terminal 2a is a destination of transmission of the data file (S32). The wireless communication terminal 2b cancels the search for a download request signal and transmits the data file selected in S20 to the wireless communication terminal 2a (S34). It is assumed here that the wireless communication terminal 2b cancels the search in response to an instruction for cancellation from the user. Alternatively, the search may automatically time out if a download request signal cannot be received within a prescribed period of time.

As described with reference to FIGS. 2 and 3, according to the data file transmission and reception method of the embodiment, the wireless communication terminal 2a requesting download originates a download request signal that initiates data file transmission and reception. The wireless and communication terminal 2b maintaining the data file selects the wireless communication terminal 2a as a destination of transmission. According to this approach, the wireless communication terminal 2b need not broadcast the fact that it maintains the data file to the other wireless communication terminals 2 in the wireless network. This allows highly personal data such as photo data to be transmitted securely.

A situation may arise where the users of the wireless communication terminals 2a and 2b decide to transmit and receive a specific data file, whereupon the data file is transmitted and received. More specifically, the user of the wireless communication terminal 2a in such a situation orally requests a specific data file from the user of the wireless communication terminal 2b. When the user of the wireless communication terminal 2b acknowledges the request, the wireless communication terminal 2a performs the operation illustrated in the flowchart of FIG. 2 and the wireless communication terminal 2b performs the operation illustrated in FIG. 3. As described, it is expected that the scheme according to the embodiment is mostly used when friends transmit and receive a specific data file between each other.

When the nicknames of wireless communication terminals 2 originating a download request are listed and the user of the wireless communication terminal 2b selects the nickname of the wireless communication terminal 2a, as described in the embodiment, the user of the wireless communication terminal 2b needs to know the nickname of the wireless communication terminal 2a beforehand. If the user does not know the nickname and if only the nickname of a single wireless communication terminal 2 is displayed in the list, the user may assume that the listed wireless communication terminal 2 is the wireless communication terminal 2a belonging to the friend. If the nicknames of a plurality of communication terminals 2 are listed, the user of the wireless communication terminal 2b may not know which of the wireless communication terminals 2 listed should be selected. For this reason, it is preferable that the user of the wireless communication terminal 2b have advance knowledge of the nickname of the wireless communication terminal 2a before selecting a destination of transmission.

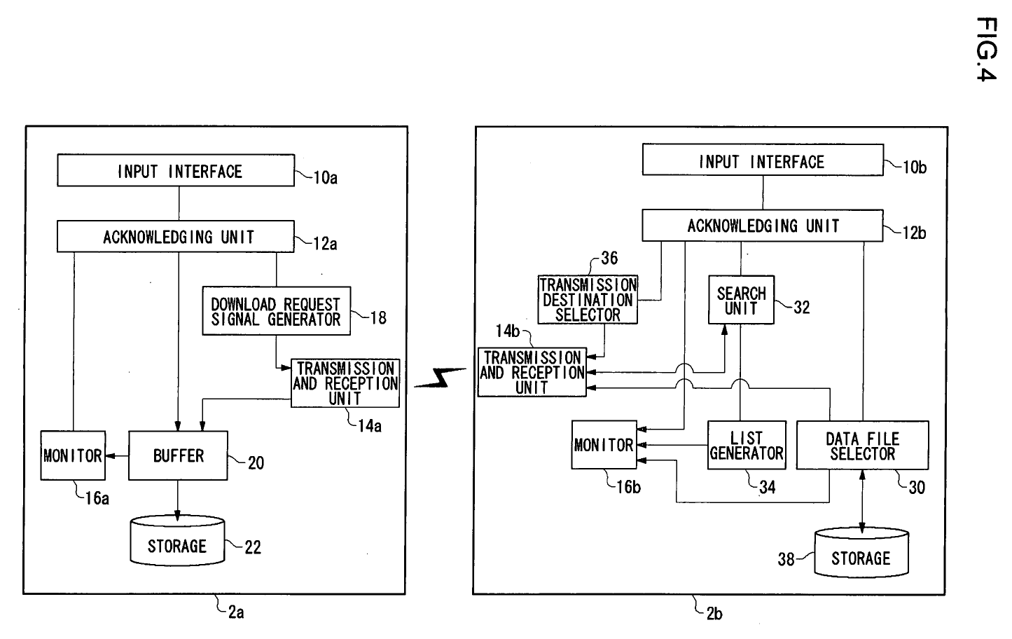

FIG. 4 is a functional block diagram showing the structure of a receiving end and a transmitting end of data file transmission. FIG. 4 highlights the receiving end structure in the wireless communication terminal 2a and the transmitting end structure in the wireless communication terminal 2b. Actually, a single unit of wireless communication terminal 2 has both the transmitting end structure and the receiving end structure.

Functions for data transmission and reception in the wireless communication terminal 2 according to the embodiment are implemented by a CPU, a memory, a program loaded into the memory, etc. FIG. 4 depicts the structure implemented by the cooperation of these elements. The program may be built in the wireless communication terminal 2 or supplied from an external source in the form of a recording medium. Therefore, it will be obvious to those skilled in the art that the functional blocks may be implemented by a variety of manners including hardware only, software only or a combination of both.

Input interfaces 10a and 10b may be a group of buttons including an arrow key that accept instructions from a user for operation. Alternatively, the input interfaces 10a and 10b may be other input tools such as a keyboard. For example, the input interfaces 10a may comprise four buttons with a circle, triangle, square and cross printed on them, respectively, and the input interface 10b may comprise four arrow keys for operations in upward, downward, leftward and rightward directions.

Acknowledging units 12a and 12b acknowledge an instruction entered from the input interfaces 10a and 10b, respectively. The instruction is acknowledged as the button or the arrow key is depressed. Monitors 16a and 16b are formed as a liquid crystal panel or a electroluminescence panel. Storages 22 and 38 may be formed as an external storage device such as a Memory Stick™ or an internal storage device such as a hard disk. Alternatively, the storages may be implemented by both. Transmission and reception units 14a and 14b are formed as a wireless interface device and have the function of both a transmitter for transmitting a signal and a receiver for receiving a signal.

The user of the wireless communication terminal 2a uses the input interface 10a to enter an instruction to request a download of a data file. The acknowledging unit 12a acknowledges the download request instruction and supplies the instruction to a download request signal generator 18. The download request signal generator 18 generates a download request signal requesting a download of a data file from another wireless communication terminal 2 belonging to the same wireless network. The download request signal generator 18 appends the nickname set up in the wireless communication terminal 2a to the download request signal. The transmission and reception unit 14a broadcasts the download request signal at prescribed intervals.

Meanwhile, the user of the wireless communication terminal 2b uses the input interface 10b to enter an instruction for selecting a data file. The acknowledging unit 12b acknowledges the instruction and supplies it to a data file selector 30. The storage 38 stores at least one data file. The data file selector 30 selects a data file from the data files stored in the storage 38, in accordance with the instruction from the user acknowledged in the acknowledging unit 12b.

If the data file to be transmitted is the data of a personal photo, the data file selector 30 displays a thumbnail of the photo data on the monitor 16b. The data file selector 30 may select photo data to be transmitted in response to the selection of a thumbnail made by the user and acknowledged by the acknowledging unit 12b. If the data file is a personal document file, the data file selector 30 displays a list of the titles of the document files on the monitor 16b. The data file selector 30 may select a document file to be transmitted in response to the selection of a title made by the user and acknowledged by the acknowledging unit 12b. Thus, the data file to be transmitted is selected in the wireless communication terminal 2b.

Subsequently, the user of the wireless communication terminal 2b uses the input interface 10b to enter an instruction for searching for a destination of transmission of the selected data file. The acknowledging unit 12b acknowledges the instruction and supplies it to a search unit 32. The search unit 32 searches for wireless communication terminal 2 originating download request signals requesting a download of a data file. More specifically, the transmission and reception unit 14b operates to receive download request signals from other wireless communication terminals 2 belonging to the same wireless network, and the search unit 32 monitors the status of reception.

When the transmission and reception unit 14b receives a download request signal from another wireless communication terminal 2, the search unit 32 retrieves the nickname appended to the download request signal and supplies it to the list generator 34. The list generator 34 uses the nickname thus retrieved and generates a list of wireless communication terminals 2 originating a download request signal.

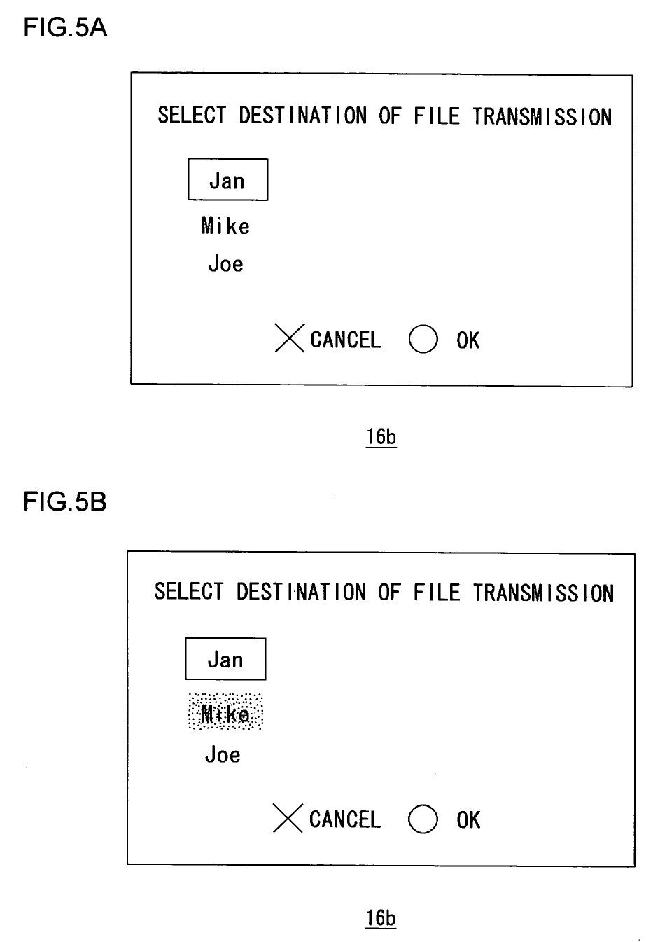

FIG. 5A illustrates an example of a list of terminals generated by the list generator. The list of terminals shows that a total of three wireless communication terminals 2 originating a download request signal are identified through the search in a given wireless network. The list of terminals lists the nicknames “Jan”, “Mike” and “Joe”, highlighting the wireless communication terminal 2 with the nickname of “Jan” by encircling the item. This means that the wireless network 2 with that nickname is temporarily selected. Depressing an OK button (in the illustrated example, the button with a circle printed on it) in the input interface 10b while the list of FIG. 5A is being displayed will select “Jan” as a destination of file transmission. Depressing a cancel button (in the illustrated example, the button with a cross printed on it) in the input interface 10b will terminate the whole process related to data transmission including search.

FIG. 5B shows another example of a list of terminals. Unlike the list of terminals shown in FIG. 5A, “Mike” is configured to be unselectable in the list of terminals. This means that “Mike” was selectable as a destination of transmission when the list of terminals shown in FIG. 5A was generated but is unselectable when the list of terminals shown in FIG. 5B was generated. For example, if the wireless communication terminal 2 identified by “Mike” stops originating a download request signal, the wireless communication terminal 2b cannot transmit a data file to the wireless communication terminal 2.

The search unit 32 monitors the status of reception of download request signals received by the transmission and reception unit 14b. When a download request signal is not received for a prescribed period of time, the search unit 32 notifies the list generator 34 that the associated wireless communication terminal 2 is unselectable. In response to the notification, the list generator 34 configures the corresponding nickname to be unselectable. By allowing the unselectable nickname to remain displayed instead of deleting it, the user of the wireless communication terminal 2b can know the status of the other wireless communication terminals 2. For example, if the transmission of a data file to the wireless communication terminal 2b with the nickname “Mike” is scheduled, the user reviewing the list of terminals shown in FIG. 5B can recognize that the wireless communication terminal 2 with that nickname transmitted a download request signal previously but is no longer transmitting a download request signal. By letting the user of “Mike” know the fact, an opportunity to address communication failure becomes available.

The user of the wireless communication terminal 2b uses the input interface 10b to move a cursor to select a desired one of selectable nicknames associated with the wireless communication terminals 2 identified through the search. The acknowledging unit 12b acknowledges the selection and supplies it to a transmission destination selector 36. In accordance with the selection acknowledged by the acknowledging unit 12b, the transmission destination selector 36 selects a transmission destination wireless communication terminal 2 from among the wireless communication terminals 2 identified through the search. It will be assumed here that the wireless communication terminal 2a corresponding to the nickname “Jan” is selected. The transmission and reception unit 14b transmits the data file selected in the data file selector 30 to the wireless communication terminal 2a determined by the transmission destination selector 36. The wireless communication terminal 2b may notify the wireless communication terminal 2a that the data file will be transmitted before the transmission occurs. In this embodiment, it is assumed that a data file is transmitted to a wireless communication terminal 2 in unicast. Alternatively, a data file may be transmitted to a plurality of wireless communication terminals 2 in multicast.

The transmission and reception unit 14a of the wireless communication terminal 2a receives the data file. The data file received is temporarily stored in a buffer 20 and displayed on the monitor 16a. The monitor 16a displays a message prompting the user to indicate whether to store the data file. If the user selects to store the file, the data file temporarily stored in the buffer 20 is stored in the storage 22. The data file received may be stored in the storage 22 before being displayed on the monitor 16a. Also in this case, the monitor 16a displays a message prompting the user to indicate whether to stored the data file. If the user selects to store, storage in the storage 22 is maintained. If the user selects not to store, the data file in the storage 22 is deleted.

Described above is the data file transmission and reception technology employed when a plurality of wireless communication terminals 2 belong to the same wireless network. According to this technology, data download is started by the broadcast of a download request signal within the wireless network from the wireless communication terminal 2a desiring download. A description will now be given of a variation of the technology for searching for a destination of transmission of a data file. In this variation, the wireless communication terminal 2b maintaining a data file participates in a wireless network in which the wireless communication terminal 2a requesting a download is a host terminal. In this way, communication between the wireless communication terminal 2a and the wireless communication terminal 2b is thus enabled. The wireless communication terminal 2a then downloads the data file from the wireless communication terminal 2b.

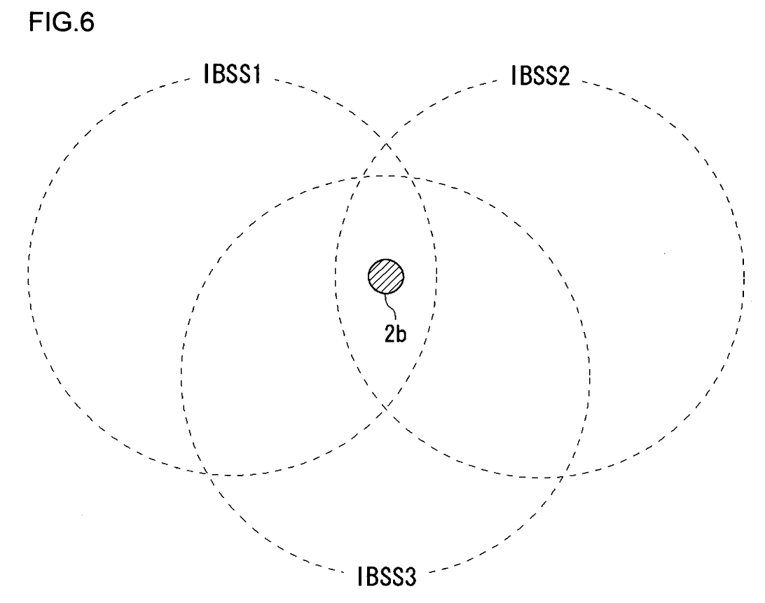

FIG. 6 shows a state in which a plurality of IBSSs are created in a given environment. In the example of FIG. 6, three IBSSs are created. A wireless communication terminal 2 is located in the communication range of IBSS1, IBSS2 and IBSS3. It is assumed that the wireless communication terminal 2b maintains a data file to be transmitted and a coordinator (host terminal) that created each IBSS desires to download a data file. In this variation, it is assumed the coordinator creates an IBSS by originating a beacon signal. An IBSS does not necessarily comprise wireless communication terminals other than the coordinator. By participating in an IBSS created by the wireless communication terminal 2a desiring to download a data file, the wireless communication terminal 2b can establish connection with the wireless communication terminal 2a to transmit the data file thereto.

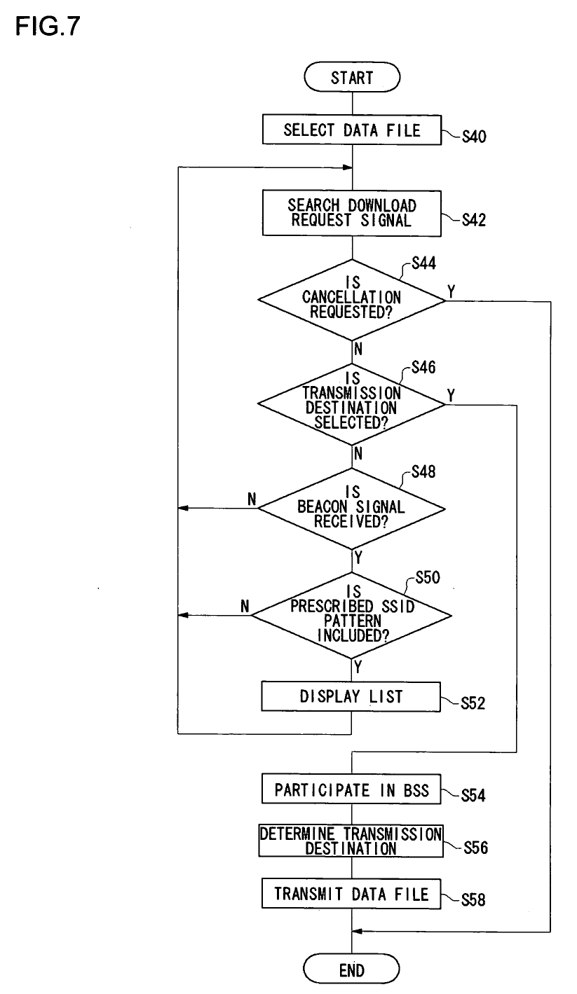

FIG. 7 illustrates a variation of the operation of a wireless communication terminal transmitting a data file. The wireless communication terminal 2b selects a data file to be transmitted in accordance with an instruction from the user (S40). One or a plurality of data files may be selected. When a data file is selected, the wireless communication terminal 2b searches in the wireless network to which it belongs for a wireless communication terminal originating a download request signal (S42). If the user of the wireless communication terminal 2b requests cancellation of a search (Y in S44), the search for a download request signal is cancelled. This completes the flow.

In this variation, a download request signal is formed as a beacon signal that includes the nickname of the wireless communication terminal 2a as well as including network information such as BSSID and SSID which are related BSS, or wireless network. The wireless communication terminal 2a desiring download of a data file originates a beacon signal to create a new wireless network (BSS) involving the wireless communication terminal 2b maintaining the data file.

If the user has not requested cancellation (N in S44) and if the user has not selected a transmission destination wireless communication terminal 2 (N in S46), the wireless communication terminal 2b determines whether a download request signal is received (S48). Selection of a destination of transmission in S46 can be performed only when a list described later is displayed. The user cannot designate a destination of transmission unless a list is displayed.

If the wireless communication terminal 2b does not receive a beacon signal (N in S48), the search is continued. If a beacon signal is received (Y in S48), the wireless communication terminal 2b determines whether the beacon signal includes a prescribed SSID pattern (S50).

Assuming a case where there are on the order of 10-1000 wireless communication terminals, the list might grow to a size that does not fit in a memory of the wireless communication terminal 2b if the wireless communication terminal 2b designates ANY as a target of search to search for all BSSs. Since the number of BSSs located in the neighborhood is unknown, a memory having a large capacity may be used to handle all possible situations. Naturally, however, the cost would be more favorable by using a memory with a small capacity. In this respect, it is favorable in terms of cost and processing time to limit the size of the list of terminals generated so that it can be handled by a small-capacity memory.

In this background, the wireless communication terminal 2b in the wireless communication system according to the variation searches for an “exchange IBSS” provided for transmission and reception of data file. The SSID of the exchange IBSS (hereinafter, referred to as an “exchange SSID”) is generated so as to include a uniquely defined prescribed pattern. The pattern may be a default value used across the wireless communication terminals 2. In this variation, the pattern will be referred to as an “exchange identification pattern”.

If the exchange identification pattern of “EXCHANGE” is employed, the exchange SSID established by the wireless communication terminal 2 desiring download (e.g. the wireless communication terminal 2a) is of a format in which a character string is attached to “EXCHANGE”. For example, the exchange SSID set up by the wireless communication terminal 2 with a nickname “Jan” may be “EXCHANGE_JAN”. The exchange SSID set up by the wireless communication terminal 2 with a nickname “Mike” may be “EXCHANGE_MIKE”. The exchange identification pattern itself may function as an exchange SSID common to wireless communication terminals 2.

The wireless communication terminal 2 examines whether the SSID retrieved from a beacon signal includes the exchange identification pattern “EXCHANGE”. The pattern “EXCHANGE” is included in some SSIDs by those wireless communication terminals 2 desiring download of a data file. Accordingly, it is known that a beacon signal including an SSID that includes “EXCHANGE” as network information is a download request signal requesting a download of a data file. If the SSID retrieved from a beacon signal does not include “EXCHANGE” (N in S50), it is ascertained that the beacon signal is not a download request signal so that the wireless communication terminal 2b continues to search for a download request signal. If the retrieved SSID includes “EXCHANGE” (Y in S50), it is determined that the beacon signal is a download request signal.

If the received beacon signal is a download request signal, the wireless communication terminal 2b retrieves a nickname included in the beacon signal so as to create a list of the nicknames. By listing only those wireless communication terminals 2 that created an SSID including a prescribed pattern, those wireless communication terminals 2 creating IBSSs that are not candidates for connection are excluded from the list. This will result in a compact list. The list lists terminals requesting a download and, more accurately, a list of BSSs to which terminals desiring download belong to.

The list of retrieved nicknames is displayed on the monitor 16b (S52). The wireless communication terminal 2b displays the list when a single download request signal is received. After displaying the list, the wireless communication terminal 2b continues to search for a download request signal. Each time the wireless communication terminal 2b receives a download request signal from another wireless communication terminal 2 in the search, the identified wireless communication terminal 2 is appended to the list. If a plurality of wireless communication terminals 2 are originating a download request signal in a wireless network, a list of the nicknames of a plurality of wireless communication terminals 2 is displayed on the monitor 16b of the wireless communication terminal 2b.

Once the list is displayed and the user selects the wireless communication terminal 2a from the listed wireless communication terminals 2 (Y in S46), the wireless communication terminal 2b participates in the BSS created by the wireless communication terminal 2a (S54). In the IBSS, the wireless communication terminal 2b determines that the wireless communication terminal 2a is a destination of transmission of a data file (S56). The wireless communication terminal 2b stops searching for a download request signal and transmits the data file selected in S40 to the wireless communication terminal 2a (S58). It is assumed here that the wireless communication terminal 2b cancels the search in response to an instruction for cancellation from the user. Alternatively, the search may automatically time out if a download request signal cannot be received within a prescribed period of time.

Described above is a method in which the wireless communication terminal 2b participates in a wireless network created by the wireless communication terminal 2a desiring download and then transmits a data file to the wireless communication terminal 2a. In this variation, the destination of transmission of a data file is determined by searching for a beacon signal that includes a prescribed SSID pattern. This process is performed by the search unit 32 of the wireless communication terminal 2b. The search unit 32 maintains an exchange identification pattern (“EXCHANGE”) and determines whether an SSID included in a beacon signal includes an exchange identification pattern. The search unit 32 retrieves the nickname of the wireless communication terminal 2 originating a beacon signal including the exchange identification pattern and delivers the nickname to the list generator 34.

The present invention has been described by citing one embodiment. The described embodiment is only illustrative in nature and it will be obvious to those skilled in the art that variations in constituting elements and processes are possible within the scope of the present invention. In the embodiment, a description is given of a case where a data file is transmitted and received in an ad hoc network. The present invention is applicable to an infrastructure network as well as to an ad hoc network. In an infrastructure network, an access point functions as a wireless communication device maintaining a data file.

What is claimed is:

1. A data file transmission method comprising:
selecting a data file to be transmitted;
searching for a wireless communication terminal requesting a download of a data file;
specifying a transmission destination wireless communication terminal based upon a result of the search; and
transmitting the selected data file to the specified wireless communication terminal.

2. A wireless communication device comprising:
a storage which stores at least one data file;
an acknowledging unit which acknowledges an instruction from a user;
a first selector which selects a data file stored in the storage, in accordance with the instruction from the user acknowledged by the acknowledging unit;
a search unit which searches for a wireless communication terminal originating a request to download a data file;
a second selector which selects a transmission destination wireless communication terminal from among the wireless communication terminals identified through the search, in accordance with an instruction from the user acknowledged by the acknowledging unit; and
a transmitter which transmits the selected data file to the transmission destination wireless communication terminal.

3. A program product comprising:
a computer executable program code module for selecting a data file to be transmitted;
a computer executable program code module for searching for a wireless communication terminal requesting a download of a data file;
a computer executable program code module for specifying a transmission destination wireless terminal, based upon a result of the search; and
a computer executable program code module for transmitting the selected data file to the specified wireless communication terminal.

4. A computer readable recording medium which stores a program product according to claim 3.
